(19) United States
(12) Patent Application Publication
(10) Pub. No.: US 2014/0218897 A1
(43) Pub. Date: Aug. 7, 2014

(54) Portable Combination Device Stand and Flashlight

(71) Applicant: James K Chun, Bellevue, WA (US)

(72) Inventor: James K Chun, Bellevue, WA (US)

(21) Appl. No.: 14/175,534

(22) Filed: Feb. 7, 2014

Related U.S. Application Data
(60) Provisional application No. 61/762,207, filed on Feb. 7, 2013.

(51) Int. Cl. F21V 33/00

(52) U.S. Cl. CPC F21V 33/00
USPC 362/154

(57) ABSTRACT

Disclosed herein is a pocket-size accessory that can acts as a stand for holding a smart cellphone, MP3 player or tablet computer with a built in flashlight unit. The accessory includes a clam shell style housing comprising an upper case and a lower case pivotally connected together along one end with the flashlight unit mounted on the inside surface on the lower case. The upper case includes two upper side arms and a lower resting lip that extends perpendicularly outward. The lower case includes an integrally formed transverse structure with two laterally extending axles that are extended into two bores form in the arm of the upper case to enable the two cases to snap fit together and pivot approximately 270 degrees. The flashlight unit includes at least one LED bulb, a printed circuit board with a voltage boosting circuit, at least one battery, and a switch. During assembly, the switch 100 extends through a hole formed on the back panel of the lower case that can be easily accessed when the accessory 10 is in an opened or closed configuration.

This utility patent application is based on U.S. provisional patent application (Application No. 61/762,207) filed on Feb. 7, 2013.

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

This invention pertains to pocket size stands for temporarily holding a cellular telephone, a MP3 player, or a standard or mini tablet computer on an horizontal surface for easier viewing and operation that can also be used as a flashlight. 2. Description of the Related Art

U.S. Pat. No. 8,631,934 discloses a pocket size accessory that functions as a compact earphone carrying case and a hands-free display stand for a cellphone, a MP3 player, or a mini tablet computer. The accessory includes an upper case and a lower case pivotally connected together along one end. The accessory may be closed into a compact configuration for transporting in the user's pocket or pulse and when desired, or opened to form a sturdy stand that holds a device in diagonal, hands-free position on a horizontal surface. Mounted on the inside surface of one case on the accessory is an earphone holding structure that enables the user to tightly wrap and store a standard wired earphone.

When the accessory is used as a hands-free display stand, the upper and lower cases are pivoted apart to form an inverted V-shaped structure. The upper case includes a resting lip that holds a cellphone, a MP3 player, or a mini tablet computer in either a landscape or portrait orientation.

Many users store their cellphones and MP3 players on nightstands and listen to an audio file or a streaming broadcast at night. More recently, clock or timer applications for the cellphones or MP3 players have become available that present the face of an alarm clock on the device's display. Such uses are especially useful for travelers who cannot listen at night to their regular radio stations or use their regular nightstand clocks.

When traveling, the user is often not familiar with the hotel room which is usually dark at night. A nearby flashlight would be desirable. Unfortunately, most travelers don't carry flashlights.

What is needed is a device that can be used as a folding stand on a horizontal surface that holds a cellphone, a MP3 player or a mini tablet computer in a viewing position on the horizontal surface and may also be used as a flashlight.

### SUMMARY OF THE INVENTION

Disclosed herein is a pocket size accessory that acts both as a display stand for a cellphone, a MP3 player or a mini-tablet computer and as a lightweight flashlight.

The accessory is small and compact designed to be carried in the user's pocket, backpack, or purse. The accessory includes a hard, clam shell style housing similar to the accessory shown and described in Applicant's U.S. patent (U.S. Pat. No. 8,631,934), and now incorporated by reference herein. The accessory includes an upper case and a lower case pivotally connected together along one end. The flashlight unit is mounted on the inside surface on the lower case and is sufficiently small to fit inside an inner cavity formed inside on the housing when the cases are closed. The upper case includes two upper side arms and a lower resting lip that extends perpendicularly outward. The lower case includes an integrally formed transverse structure with two laterally extending axles that are extended into two bores form in the arm of the upper case to enable the two cases to snap fit together and pivot 270 degrees and temporarily lock in an extended position.

The flashlight unit is self-contained and includes at least one LED bulb, a printed circuit board with a voltage boosting circuit, at least one battery, and an externally mounted switch. When assembled in the lower case and the two cases are closed, the LED bulb extends through an end opening formed on the lower case and through a slotted bulb opening formed on the end wall of the upper case. In the embodiment shown herein, the switch is perpendicularly mounted on the outside surface of the flashlight unit that is placed adjacent to the inside surface of the lower case. During assembly, the switch extends through a hole formed on the back panel of the lower case that can be easily accessed when the case is closed.

Because the LED bulb optimally operates at 4.5 volts, a voltage multiplying circuit is provided that raises the battery voltage from 1.5 volts to approximately 4.5 volts.

The flashlight unit may be housed in a protective outer shell. Optional holding tabs may be provided on the inside surface of the lower case to hold the outer shell in place on the lower case.

### DESCRIPTION OF THE DRAWINGS

FIG. 1 is a front perspective view of the multi-functional video device accessory shown in an opened configuration and holding a display device in the diagonally aligned upper case and the lower case holding the flashlight unit.

FIG. 2 is a front perspective view of the multi-functional device accessory shown in a closed configuration.

FIG. 3 is a side elevational view of the display device shown in FIG. 1.

FIG. 4 is a rear perspective view of the multi-functional display device accessory shown in FIGS. 1 and 3.

FIG. 5 is a side elevational view of the accessory showing the lower case vertically aligned and the upper case horizontally aligned on a support surface and showing the flashlight unit activated.

FIG. 6 is a side elevational view of the accessory shown in FIG. 2 in a closed configuration.

FIG. 7 is a rear elevational view of the accessory shown in FIGS. 2 and 6.

FIG. 8 is a front elevational view of the accessory shown in FIGS. 2, 6 and 7.

FIG. 9 is an exploded perspective view of the accessory.

FIG. 10 is a side elevational view of the flashlight unit

FIG. 11 is an end elevational view of the flashlight unit.

FIG. 12 is a schematic diagram of the printed circuit board and the electrical circuit formed in the accessory.

### DESCRIPTION OF THE PREFERRED EMBODIMENT(S)

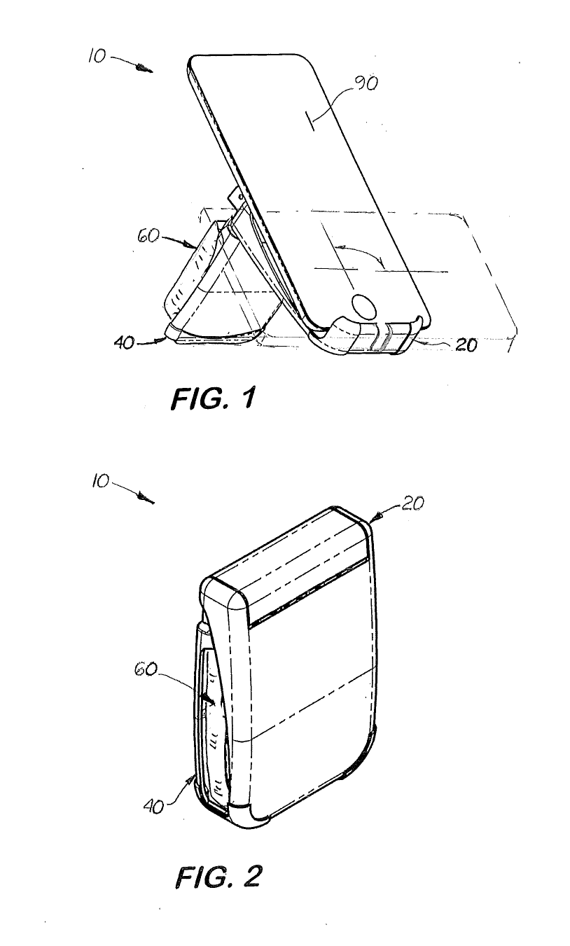

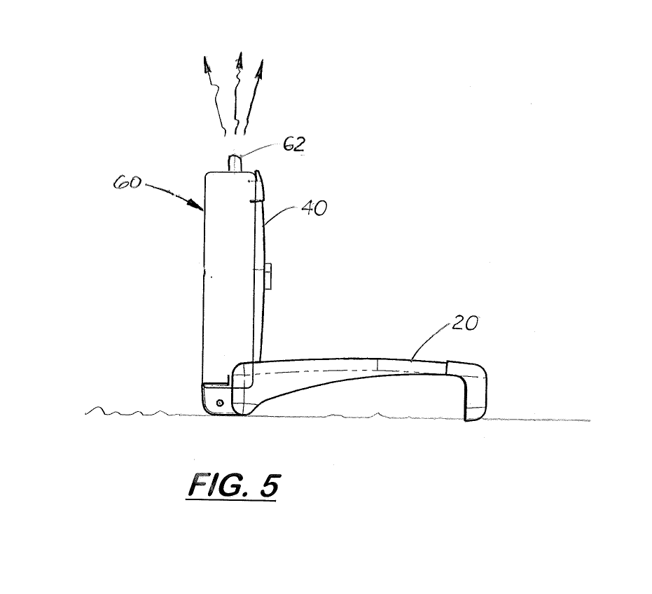

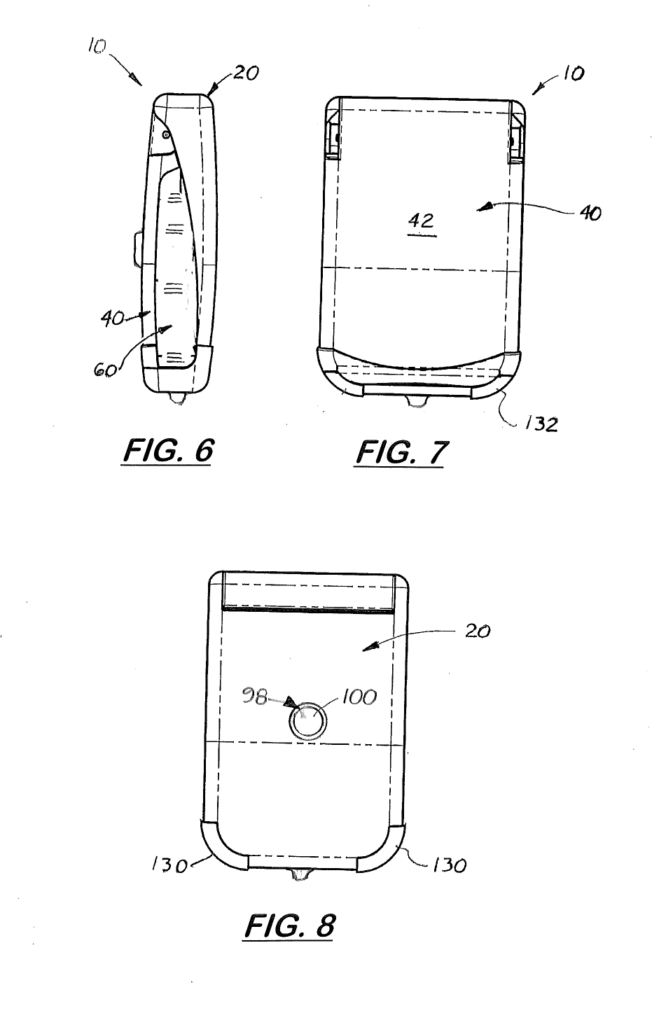

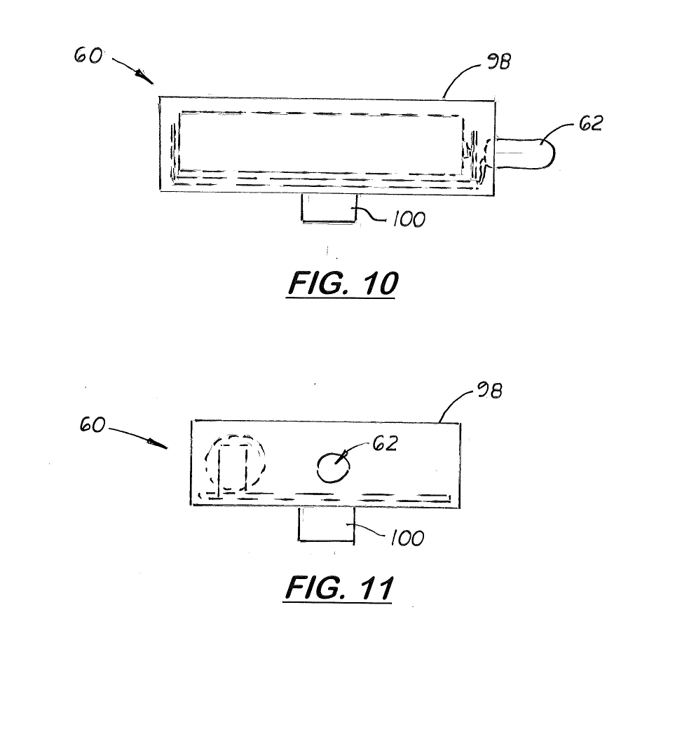

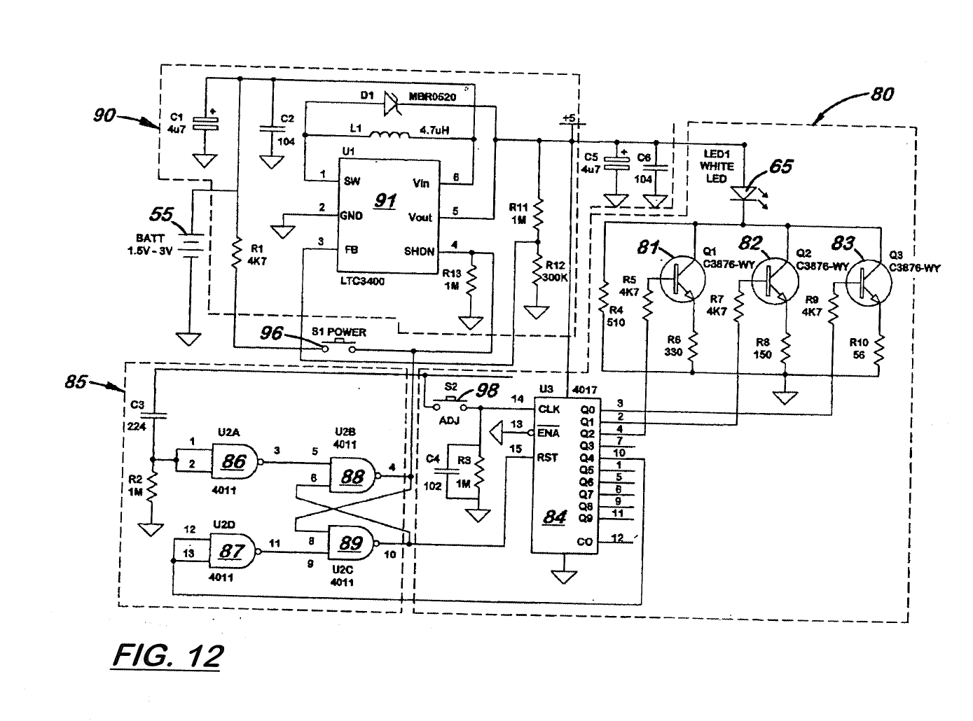

Referring to the accompanying FIGS. 1-12, there is shown a pocket-size accessory 10 that can acts as a stand for holding a smart cellphone, a MP3 player or a mini-tablet computer (called a device and indicated generally in the Figs by the reference number 60) with a self-containing flashlight unit 60. The accessory 10 includes a clam shell style housing 12 comprising an upper case 20 and a lower case 40 pivotally connected together along one end with the flashlight unit 60 mounted on the inside surface on the lower case 40. The upper case includes two upper side arms 30, 34 and a lower resting lip 36 that extends perpendicularly outward. The lower case 40 includes an integrally formed transverse structure with two laterally extending axles that are extended into two bores form in the side arms 30, 34 of the upper case 20 to enable the two cases 20, 40 to snap fit together and pivot approximately 270 degrees.

The flashlight unit 60 is a self-contained, low profile, flat rectangular or square structure that includes at least one LED bulb 62, a printed circuit board 64 with a voltage boosting circuit 80, at least one battery 55, and an externally mounted switch 100.

When the accessory 10 is manipulated into an open configuration, as shown in FIGS. 1, 3 and 4, the upper case 20 is diagonally aligned to support a device 90 for optimal viewing. When the accessory 10 is manipulated into a closed configuration as shown in FIGS. 2, 6, 7, and 8, the flashlight unit 60 is protected and the overall size of the accessory 10 is reduced for easy portability in the user's pocket or purse. The LED bulb 62 extends outward from the end opening 41 on the lower case 40 and thru the slotted bulb opening when the case is closed.

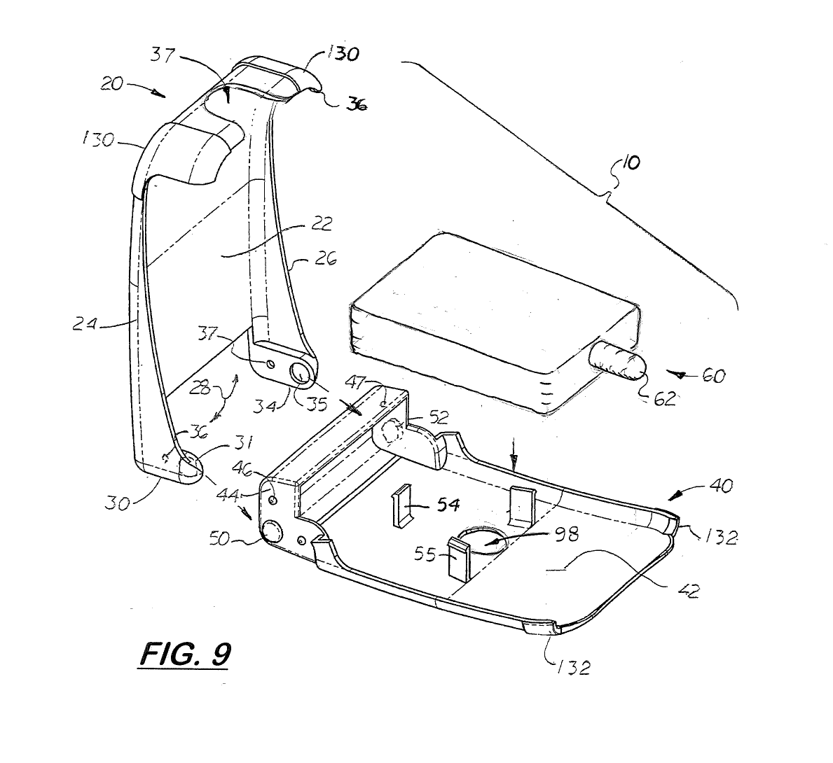

More specifically, the accessory 10 includes a clam shell-style housing 12 comprising an upper case 20 and a lower case 40 pivotally connected together along one end with a replaceable flashlight unit 60 mounted on the inside surface on the lower case 40. As shown more clearly in FIG. 9, the upper case 20 is a planar structure that includes a main panel 22, two inward extending side walls 24, 26. The main panel 22 is shorter than the two side walls 24, 26, and thereby forming a wide top opening 28 surrounded by two parallel side arms 30, 34. Formed on the opposite end of the main panel 22 is a transversely aligned resting lip 36 that extends substantially perpendicular to the main panel 22. When the housing 12 is disposed in a closed position, the resting lip 36 forms an end support surface for a device 90. Formed on the resting lip 36 is a slotted bulb opening 37. When the housing 12 is disposed in an open position, the resting lip 36 forms a support structure capable of receiving the lower or side edge of a device 90. Formed on each side arm 30, 34 is an axle bore 31, 35, respectively.

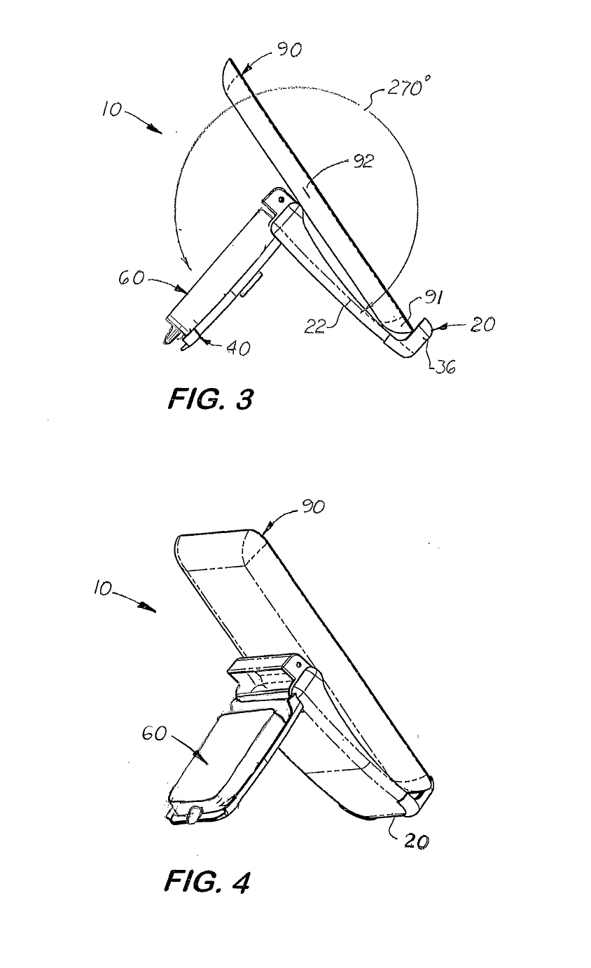

The lower case 40 is also a planar structure and includes main panel 42 with a hollow, upper transverse structure 44. Formed on the opposite ends of the transverse structure 44 are two laterally extending axles 50 52 that snap fit into the two axle bores 31, 35 formed the upper case's side arms 30, 34, respectively. As mentioned above, the upper case 20 includes a top opening 28 in which the transverse structure 44 is inserted to pivotally connect the upper case 20 and lower case 40 together. The size of the transverse structure 44 is sufficient so that it does not touch or interfere with a device 90 placed against the upper case 20. In the preferred embodiment, the width and height of the transverse structure 44 is sufficient so that the upper case 20 and lower case 40 when connected together may to pivot approximately 270 degrees between a closed, planar configuration to open configuration as shown in FIG. 3. When pivoted to an open position, the upper case 20 and lower case 40 are diagonally aligned and converge along a top edge to support a device 90 oriented in portrait orientation or in a landscape orientation as shown in FIG. 1.

The flashlight unit 60 is designed to fit into the inner cavity 38 formed between the upper case 20 and the lower case 40 when disposed in a closed configuration. As shown more clearly in FIGS. 8-13, when upper case 20 and the lower case 40 are closed, the LED bulb 62 extends through the end opening 41 on the lower case 40 and through a slotted bulb opening 37 formed on the end lip structure 36 of the upper case 20. Also the switch 100 is located centrally on the flashlight unit 60 and is perpendicular to the flashlight unit's longitudinal axis. During assembly, the switch 100 extends through a hole 98 formed on the back panel of the lower case 40 that can be easily accessed when the accessory 10 is in an opened or closed configuration. Because the LED bulb 62 optimally operates at 4.5 volts, a voltage multiplying circuit 80 is provided that raises the battery voltage on a single AAA or AA battery from 1.5 volts to approximately 4.5 volts. The flashlight unit 60 may be housed in a protective outer shell 96. Optional holding tabs may be provided on the inside surface of the lower case 40 to hold the outer shell 96 in place on the lower case 40.

In one embodiment, the housing 12 is made of plastic and measures approximately ⅝ inches in height, 2½ inches in length, and 1¾ inches in width. In one embodiment, optional gripping pads 120 and 125 are attached the lower ends or the upper case 20 and an lower case 40 to increase the frictional forces to hold the housing in an open configuration on horizontal surface. Also, optional holes 36, 37 and pegs 46, 47 may be formed on the adjacent surfaces of the side arms 30, 34 and the ends of the transverse structure 44 to temporarily resist accidental movement from the closed or opened positions.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. An accessory comprising:
a. a compact, clam shell-style housing with a center storage area, said housing includes an upper case and a lower case pivotally connected together, said upper case and said lower being configured so that said upper case and said lower case may be pivoted together to form a closed housing surround an inner cavity or pivoted apart to an inverted V shape configuration with an inside surfaces of said upper case and an inside surface of said lower case being exposed, said upper case includes a transversely aligned resting lip structure and said lower case includes an end opening; and,
b. a flashlight unit mounted on said inside surface on said lower case, and configure to fit inside said inner cavity when said upper case and said lower case are closed, said flashlight unit includes at least one LED bulb, at least one battery connected to the LED bulb, a and a switch, said LED extending from one end of said flashlight unit and through said end opening on said lower case.

2. The accessory as recited in claim 1, wherein said switch extends through said lower case when said flashlight unit is mounted on said lower case.

3. The accessory as recited in claim 1, wherein the LED extends through a slot opening form on said resting lip structure when upper and lower cases are in a closed configuration.

4. The accessory as recited in claim 1, further including a voltage multiplying circuit disposed between the LED bulb and the battery.
